(19) United States
(12) Patent Application Publication
(10) Pub. No.: US 2006/0039779 A1
(43) Pub. Date: Feb. 23, 2006

(54) Snap staples

(76) Inventor: Edward Arthur Ringl, Temple, GA (US)

Correspondence Address: EDWARD ARTHUR RINGL JR., 365 Rainey Rd, Temple, GA, 30179, US

(21) Appl. No.: 10/900,414

(22) Filed: Jul. 28, 2004

(51) Int. Cl. F16B 15/00

(52) U.S. Cl. 411/457

(57) ABSTRACT

The Snap Staple is a new way in order to make a staple more versatile. Giving everyone options in which are not available today. It also has the ability to save monies for many companies in many areas.

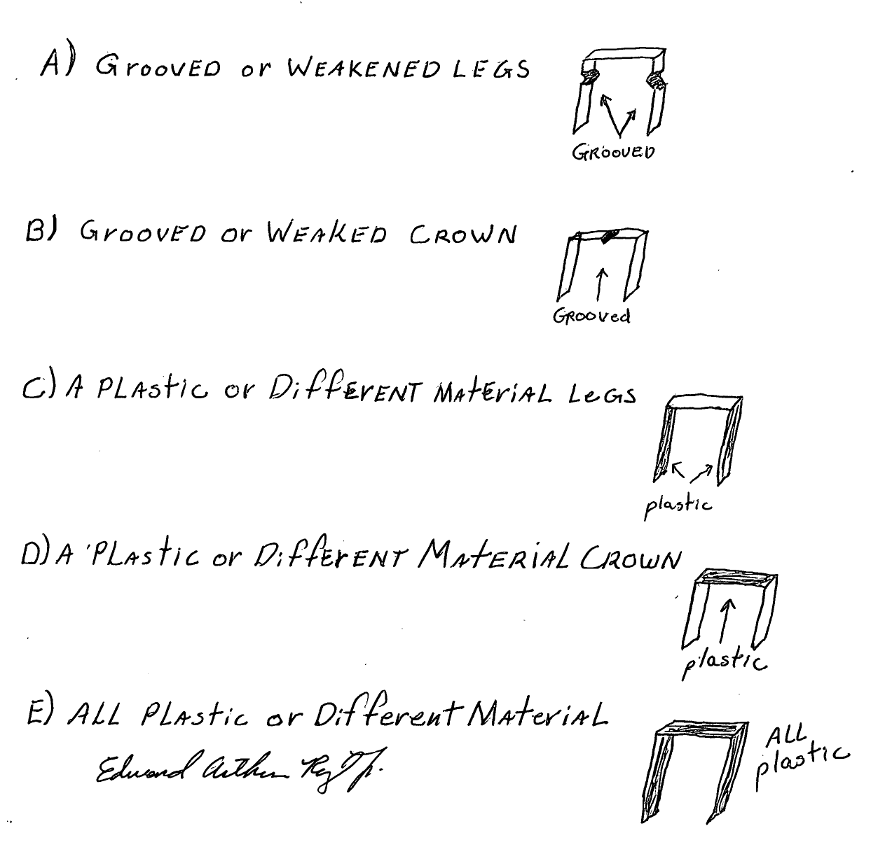

The invention that I am presenting I call, the Snap Staple. It is unique in design and in utility for several reasons. In the design part, the staple is weakened for the purpose of being able to break apart with little or no effort. This is accomplished several different ways. (a) Making the entire staple out of plastic or some other form of easily breakable material. (b) Making part of the staple out of plastic or some other breakable material. (c) A Grooving, thinning, or other method of making the metal in which the staple is made out of weaker, to make it break apart.

The utility is unique because the Snap Staple will be used when the item(s) being stapled is for temporary use.

It is a staple that is a change from any of the normal staples that are in use today in the office, school, the construction, convention, trade show, catering and other production services.

What I am presenting is any change that is of any difference to the normal metal staple that is in use today. Whether it is in an office with a folding type staple. E.g. when stapling two or more sheets of paper together in office. Or a production type use where the staple doesn't fold. E.g. used when stapling skirting onto tables or two pieces wood together for a stability purpose.

To make this invention you would use the conventional way of making a staple, by the pressing method from steel. The difference could be the material that you would use and/or could be the design change of the existing material.

Snap Staples are a staple(s) made to break apart when needed, instead of the now more permanent type of industry and office staple. This is mainly for temporary type jobs where staples are used, such as in the catering industry, convention industry, construction, and temporary setups for any party or event type needs where staples are used for things like stapling skirting onto tables, hanging streamers and banners, and temporary structures.

This also pertains to an office adaptation when items (mainly paper) are to be attached together, and then re-separated for meetings or other projects. Later to be re-attached and possibly re-separated over and over again.

### CROSS-REFERENCE TO RELATED APPLICATIONS

None found STATEMENT REGARDING FEDERALLY SPONSORED RESEARCH OR DEVELOPMENT

Not Applicable

### BACKGROUND OF THE INVENTION

The snap staple would be an easier and labor saving way in which to apply staples. I'm attempting to expand on the use of the basic staple and open doors of economic enhancements as well. In the economics area there would be at least two fields, #1) the labor savings that is associated with the staples used today. #2) the cost in the market, because of more options for the use of the staple, more choices for better performance, there would be a larger market.

I have found no references of any sort of anyone trying this invention or anything like it in the past. The market for such an idea is mainly related to the Convention, Trade Show, and Catering type of businesses, but also goes into the Construction field and the office field in smaller adaptation portions.

There is a huge market in the Convention and Trade Show industries for this type of staple. A staple that would not be an adaptation to fit the industries needs. One area in which Snap Staples would save monies is the labor that is used for just the removal of the older type non-breakable staples. E.g. removing the staples from the table skirting after the trade show or event. This takes approximately 3 minutes or more per skirt. Snap Staples would eliminate this time. There are other areas in the Trade show, convention, and catering, and other industries were this type of staple can and would be a benefit. As in the hanging and removal of streamers, banners, pictures, and temporary structures just to name a few.

In the construction field there are temporary stabilizers being built everywhere. The stabilizing boards are discarded after being used and are thrown away. The Snap Staple would prevent the waste of such material, by being able to reuse the board(s). Not only saving a company time and labor, but would also benefit everyone by less waste for the Land Fills.

I would like to capture as much of the market as soon as I can, its just good business.

### BRIEF DESCRIPTION OF THE SEVERAL VIEWS OF THE DRAWING

A. Weakened Legs, a groove or thinning of the material used in the formation in the legs of the staple.

B. Weakened Top/Bridge, a groove or thinning of the material used in the formation of the top of the staple.

C. Changed leg, making the legs of the staple out of a different material in order to weaken that portion of the staple.

D. Changed Top/Bridge, making the top of the staple out of a different material in order to weaken that portion of the staple.

E. Different Material, making the whole staple out of plastic or other material.

### BRIEF SUMMARY OF THE INVENTION

The snap staple would be an easier and labor saving way in which to apply staples. I'm attempting to expand on the use of the basic staple and open doors of economic enhancements as well. In the economics area there would be at least two fields, #1) the labor savings that is associated with the staples used today. #2) the cost in the market, because of more options for the use of the staple, more choices for better performance, there would be a larger market.

I have found no references of any sort of anyone trying this invention or anything like it in the past. The market for such an idea is mainly related to the Convention, Trade Show, and Catering type of businesses, but also goes into the Construction field and the office field in smaller adaptation portions.

There is a huge market in the Convention and Trade Show industries for this type of staple. A staple that would not be an adaptation to fit these industries needs. One area in which Snap Staples would save monies is the labor that is used for just the removal of the older type non-breakable staples. E.g. removing the staples from the table skirting after the trade show or event. This takes approximately 3 minutes or more per skirt. Snap Staples would eliminate this time. There are other areas in the Trade show, convention, and catering, and other industries were this type of staple can and would be a benefit. As in the hanging and removal of streamers, banners, pictures, and temporary structures just to name a few.

In the construction field there are temporary stabilizers being built everywhere. The stabilizing boards are discarded after being used and are thrown away. The Snap Staple would prevent the waste of such material, by being able to reuse the board(s). Not only saving a company time and labor, but would also benefit everyone by less waste for the Land Fills.

I would like to capture as much of the market as soon as I can, its just good business.

### DETAIL DESCRIPTION OF THE INVENTION

It has come to my attention through persons related to me and not. After doing several events at my home and other places, such as birthday parties, Christmas parties and decorations for Halloween parties and 4^{th} of July, etc. . . . Applying the decorations, streamers, banners, skirting, and other decorating items using a staple gun, I found that the removal of the staple after the event was a time consuming and tedious job.

The idea of the snap staple came about from the notion that it would be easier to have the staples break at some point. The staples “legs” would break off inside the object it was applied to and the “bridge” or top (crown) would fall away. Leaving almost no trace of the staple in any of the objects stapled. Also almost eliminating the labor it takes to remove the staple from either object. This also would help in the repair time that it takes to repair the damage done by a staple. The “pulling” out motion of the staple may cause more damage to the item than the initial stapling for example.

The process in which to make the snap staples not change much different from the process in which staples are made now, by stamping out of metal. As well as in the machining and the manufacturing also would not change much. The composite of the material would be different in some cases. As would the configuration of the staple in some cases from the way in which they are made today.

I- What I claim as my invention is the idea of a staple made with the ability to break apart.

II- What I claim as my invention is the idea and/or concept of a breakable staple in any form of an idea and/or the ability for a staple to be made to break apart.
The Snap Staple is a staple that is made to break apart to prevent damage to objects and to save labor. Break apart by either a groove or weakened piece in the “legs” and/or “crown” (top, bridge) of the now all-metal staples used, or by making a staple from part or all of a breakable material to cause this same effect.
The idea of the snap staple came about from the notion that it would be easier to have the staples break at some point. The staples “legs” would break off inside the object it was applied to and the “bridge” or top (crown) would fall away. Leaving almost no trace of the staple in any of the objects stapled when removed. Also almost eliminating the labor it takes to remove the staple from the object(s), bending it over, or whatever method is used to remove the staple residue.
This also would help in the repair time that it takes to repair the damage done by a staple. The “pulling” out motion of the staple may cause more damage to an item than the initial stapling.
